(19) United States
(12) Patent Application Publication
(10) Pub. No.: US 2022/0360827 A1
(43) Pub. Date: Nov. 10, 2022

(54) CONTENT DISTRIBUTION SYSTEM, CONTENT DISTRIBUTION METHOD, AND CONTENT DISTRIBUTION PROGRAM

(71) Applicant: DWANGO Co., Ltd., Tokyo (JP)

(72) Inventor: Nobuo KAWAKAMI, Tokyo (JP)

(73) Assignee: DWANGO Co., Ltd., Tokyo (JP)

(21) Appl. No.: 17/765,129

(22) PCT Filed: Nov. 5, 2020
(86) PCT No.: PCT/JP2020/041380

§ 371 Date: Mar. 30, 2022

(30) Foreign Application Priority Data
Dec. 26, 2019 (JP) 2019-236669

(51) Int. Cl. H04N 21/232; H04N 21/466; G09B 5/00

(52) U.S. Cl. CPC H04N 21/232; H04N 21/4667; G09B 5/00

(57) ABSTRACT

A content distribution system according to one embodiment acquires content data of existing content representing a virtual space, analyzes the content data to dynamically set at least one scene in the content as at least one candidate position for cueing in the content, and sets one of the at least one candidate position as a cueing position.

### TECHNICAL FIELD

Aspects of the present disclosure are related to a content distribution system, a content distribution method, and a content distribution program.

### BACKGROUND ART

Techniques for controlling the cueing of content are known. For example, Patent Document 1 describes a method for easily cueing HMD video that satisfies a predetermined condition when playing back recorded HMD video by making information used to manipulate virtual objects visible along a time axis.

### CITATION LIST

### Patent Literature

Patent Document 1: JP 2005-267033 A

### SUMMARY OF INVENTION

### Technical Problem

A mechanism is desired that makes the cueing of content representing virtual space easier.

### Solution to Problem

The content distribution system in one aspect of the present disclosure comprises one or more processors. At least one of the one or more processors acquires content data on existing content that represents virtual space. At least one of the one or more processors analyzes the content data to dynamically set at least one scene in the content as one or more candidate positions for cueing in the content. At least one of the one or more processors sets one of the one or more candidate positions as a cueing position.

In this aspect of the present disclosure, predetermined scenes in the virtual space are set as candidate positions for cueing, and a cueing position is set from these candidate positions. Viewers can easily cue content by performing this processing, which is not described in Patent Document 1.

### Advantageous Effects of Invention

This aspect of the present disclosure makes cueing of content representing virtual space easier.

### BRIEF DESCRIPTION OF DRAWINGS

FIG. 1 is a diagram showing an example of the content distribution system applied in an embodiment.

FIG. 2 is a diagram showing an example of the hardware configuration related to the content distribution system in the embodiment.

FIG. 3 is a diagram showing an example of the functional configuration related to the content distribution system in the embodiment.

FIG. 4 is a sequence diagram showing an example of content cueing in the embodiment.

FIG. 5 is a diagram showing an example of display of a cueing candidate position.

FIG. 6 is a sequence diagram showing an example of changing the content.

FIG. 7 is a diagram showing an example of changing the content.

FIG. 8 is a diagram showing another example of changing the content.

### DESCRIPTION OF EMBODIMENTS

An embodiment of the present disclosure will now be described in detail with reference to the appended drawings. In the description of the drawings, identical or similar elements are denoted by the same reference numbers and redundant description of these elements has been omitted,

### [System Overview]

The content distribution system in the present embodiment is a computer system that distributes content to users. This content is provided by a computer or a computer system and is information in a form that is recognizable to people. The electronic data indicating the content is referred to as content data. There are no particular restrictions on the form that this content takes. Content may take the form of video (still images, moving images, etc.), text, audio, music, or a combination of two or more of these forms. The content can be used to disseminate information or to communicate for a variety of purposes, including entertainment, news, education, medical information, games, chat, commerce, lectures, seminars, or training.

Distribution refers to processing in which information is sent to users via a communication network or broadcasting network. In the present disclosure, distribution is a concept that may include broadcasting.

The content distribution system distributes content to users by sending content data to user terminals. In this example, the content is provided by a distributor. A distributor is a person who wishes to convey information to users. In other words, the distributor is a content distributor. A viewer is a person who wants to obtain this information, that is, a user of the content.

In the present embodiment, the content is composed at least of video. Video showing content is “content video”. Content video is video that allow a person to view and recognize information. Content video may be moving images (video) or still images.

This content may be moving images or still images.

In one example, the content video represents a virtual space in which virtual objects are present. A virtual object is an object that does not actually exist in the real world and is represented only in a computer system. Virtual objects are represented by two-dimensional or three-dimensional computer graphics (CG) using video content that is independent of live-action video. There are no particular restrictions on the method used to represent virtual objects. For example, a virtual object may be represented using animation or may be represented closer to the real thing using live-action video. Virtual space is a virtual two-dimensional or three-dimensional space represented by video displayed on a computer. Put another way, content video can be said to be video showing scenery from a virtual camera set in virtual space. A virtual camera is set in virtual space so as to correspond to the line of sight of the user who is viewing the content video. Content video or virtual space may include real objects that actually exist in the real world.

An example of a virtual object is an avatar, which is the user's alter ego. The avatar is represented by two-dimensional or three-dimensional computer graphics (CG) using video data independent of original video not of the person captured on video. There are no restrictions on the method used to represent an avatar. For example, an avatar may be represented using animation or may be represented closer to the real thing using live-action video.

There are no restrictions on the avatars included in content video. For example, an avatar may correspond to a distributor or may correspond to a participant who is participating in the content together with the distributor and is a user who is viewing the content. A participant can be said to be a type of viewer.

Content video may show a person who is a performer or may show an avatar instead of the performer. The distributor may or may not appear in the content video as a performer. Viewers can experience augmented reality (AR), virtual reality (VR), or mixed reality (MR) by viewing the content video.

The content distribution system may be used for time-shifted viewing in which content can be viewed for a given period after real-time distribution. Alternatively, the content distribution system may be used for on-demand distribution in which content can be viewed at any time. The content distribution system distributes content represented using content data generated and stored sometime in the past.

In the present disclosure, the expression “sending” data or information from a first computer to a second computer means sending data or information for final delivery to a second computer. This expression also includes situations in which another computer or communication device relays the data or information being sent.

As mentioned above, there are no restrictions on content in terms of purpose and use. For example, the content may be educational content, and the content data may be educational data. Educational content is content used by teachers to instruct students. A teacher is a person who teaches, for example, academics or a skill, and a student is a person who is the recipient. A teacher is an example of a distributor and a student is an example of a viewer. The teacher may be a person with a teacher's license or a person without a teacher's license. Class work refers to a teacher teaching students academics or skills. There are no restrictions on the age and affiliation of either the teacher or the students, and thus there are no restrictions on the purpose and use of the educational content. For example, the educational content may be used by schools such as nursery schools, kindergartens, elementary schools, junior high schools, high schools, universities, graduate schools, vocational schools, preparatory schools, or online schools. It may also be used in places or situations other than school. In this regard, educational content may be used for various purposes such as early childhood education, compulsory education, higher education, or lifelong learning. In one example, the educational content includes an avatar that corresponds to a teacher or a student, which means that the avatar appears in at least some scenes of the educational content,

### [System Configuration]

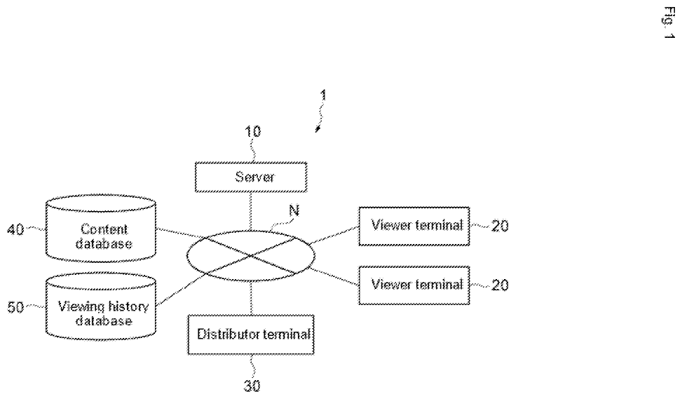

FIG. 1 is a diagram showing an example of the content distribution system 1 applied in an embodiment. In the present embodiment, the content distribution system 1 includes a server 10. The server 10 is a computer that distributes content data. The server 10 connects to at least one viewer terminal 20 via a communication network N. FIG. 1 shows two viewer terminals 20, but there are no restrictions at all on the number of viewer terminals 20. The server 10 may be connected to a distributor terminal 30 via the communication network N. The server 10 is also connected to a content database 40 and a viewing history database 50 via the communication network N. There are no restrictions on the configuration of the communication network N. For example, the communication network N may be configured to include the Internet or an intranet.

A viewer terminal 20 is a computer used by a viewer. The viewer terminal 20 has a function that accesses the content distribution system 1 to receive and display content data. There are no restrictions on the type or configuration of the viewer terminal 20. For example, the viewer terminal 20 may be a mobile terminal such as a mobile phone, a high-performance mobile phone (smartphone), a tablet terminal, a wearable terminal (for example, a head-mounted display (HMD) or smart glasses), or a laptop computer. Alternatively, the viewer terminal 20 may be a stationary terminal such as a desktop computer. Alternatively, the viewer terminal 20 may be a classroom system equipped with a large screen installed in a room.

The distributor terminal 30 is a computer used by a distributor. In one example, the distributor terminal 30 has a function for shooting video and a function for accessing the content distribution system 1 and sending electronic data (video data) of the video. There are no restrictions on the type or configuration of the distributor terminal 30. For example, the distributor terminal 30 may be a videography system having a function of capturing, recording, and sending video. Alternatively, the distributor terminal 30 may be a mobile terminal such as a mobile phone, a high-performance mobile phone (smartphone), a tablet terminal, a wearable terminal (for example, a head-mounted display (HMD) or smart glasses), or a laptop computer. Alternatively, the distributor terminal 30 may be a stationary terminal such as a desktop computer.

A viewer operates a viewer terminal 20 to log into the content distribution system 1 so that the viewer can view content. The distributor operates a distributor terminal 30 to log into the content distribution system 1 so that the distributor can provide content to viewers. In the description of the present embodiment, the users of the content distribution system 1 have already logged in.

The content database 40 is a non-temporary storage medium or storage device for storing content data that has been generated. The content database 40 can be said to be a library of existing content. The content data can be stored in the content database 40 by the server 10, the distributor terminal 30, or some other computer.

The content data is stored in the content database 40 after being associated with a content ID that uniquely identifies the content. In one example, content data is configured to include virtual space data, model data, and scenarios.

The virtual space data is electronic data indicating the virtual space constituting the content. For example, the virtual space data may indicate the arrangement of virtual objects constituting the background, the position of a virtual camera, or the position of a virtual light source.

The model data is electronic data used to indicate the specifications of the virtual objects constituting the content. Virtual object specifications indicate the arrangement or method used to control a virtual object. For example, specifications include at least one of the configuration (for example, shape and dimensions), behavior, and audio for a virtual object. There are no particular restrictions on the data structure for the model data of an avatar, which may be designed using any data model. For example, the model data may include information about the joints and bones constituting the avatar, graphic data showing the designed appearance of the avatar, attributes of the avatar, and an avatar ID used to identify the avatar. Examples of information about joints and bones include the three-dimensional coordinates of individual joints and the combination of adjacent joints (that is, bones). Avatar attributes can be any information used to characterize an avatar, and may include, for example, the nominal dimensions, voice quality, or personality of the avatar.

A scenario is electronic data that defines the behavior of an individual virtual object, virtual camera, or virtual light source over time in virtual space. A scenario can be said to be information used to determine the story of the content. Movement of the virtual object is not limited to movement that can be visually recognized. It may also include sounds that can be perceived audibly. The scenario contains motion data indicating when and how each virtual object behaves.

Content data may include information about real objects. For example, content data may include live-action video in which a real object has been captured. When content data contains a real object, the scenario may also specify when and where the real object appears.

The viewing history database 50 is a non-temporary storage medium or storage device that stores viewing data indicating the fact that a viewer has viewed the content. Each record for viewing data includes a user ID used to uniquely identify a viewer, the content ID of the viewed content, the viewing date and time, and operation information indicating how the viewer interacted with the content. In the present embodiment, the operation information includes cueing information related to cueing. Therefore, viewing data can be said to be data showing the history of cueing performed by each user. The operation information may also include the playback position in the content where the viewer finished viewing the content (the “playback end position” below).

There are no restrictions on the location of each database. For example, at least one of the content database 40 and the viewing history database 50 may be provided in a computer system different from the content distribution system 1, or may be a component of the content distribution system 1.

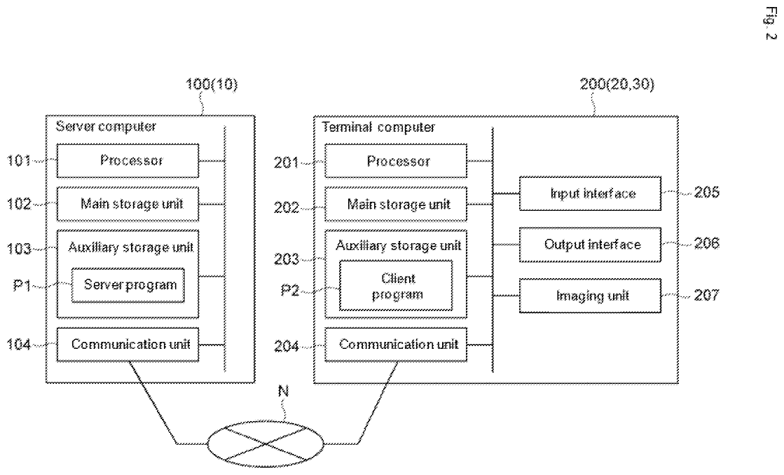

FIG. 2 is a diagram showing an example of the hardware configuration related to the content distribution system 1. FIG. 2 shows a server computer 100 that functions as a server 10 and a terminal computer 200 that functions as a viewer terminal 20 or a distributor terminal 30.

In one example, the server computer 100 includes a processor 101, a main storage unit 102, an auxiliary storage unit 103, and a communication unit 104 as hardware components.

The processor 101 is an arithmetic unit that executes the operating system and application programs. Examples of processors include CPUs (central processing units) and GPUs (graphics processing units), but the processor 101 is not restricted to either of these types. For example, the processor 101 may be a combination of a sensor and a dedicated circuit. The dedicated circuit may be a programmable circuit such as an FPGA (field-programmable gate array), or some other type of circuit.

The main storage unit 102 is a device that stores a program for realizing the server 10 and operating results output from the processor 101. The main storage unit 102 is composed of, for example, at least one of a ROM (read-only memory) and a RAM (random-access memory).

The auxiliary storage unit 103 is usually a device that can store a larger amount of data than the main storage unit 102. The auxiliary storage unit 103 is composed of a non-volatile storage medium such as a hard disk or a flash memory. The auxiliary storage unit 103 stores the server program P1 and various types of data used to make the server computer 100 function as a server 10. For example, the auxiliary storage unit 103 may store data for virtual objects such as avatars and/or virtual space. In the present embodiment, the content distribution program is implemented as a server program P1.

The communication unit 104 is a device that performs data communication with other computers via a communication network N. The communication unit 104 can be, for example, a network card or a wireless communication module.

Each functional element of the server 10 is realized by loading the server program P1 in the processor 101 or the main storage unit 102 to get the processor 101 to execute the program. The server program P1 contains code for realizing each functional element of the server 10. The processor 101 operates the communication unit 104 according to the server program P1 to write and read data to and from the main storage unit 102 or the auxiliary storage unit 103. Each functional element of the server 10 is realized by this processing.

The server 10 may be composed of one or more computers. When a plurality of computers are used, one server 10 is logically configured by connecting these computers to each other via a communication network.

In one example, the terminal computer 200 includes a processor 201, a main storage unit 202, an auxiliary storage unit 203, a communication unit 204, an input interface 205, an output interface 206, and an imaging unit 207 as hardware components.

The processor 201 is an arithmetic unit that executes the operating system and application programs. The processor 201 can be a CPU or GPU, but the processor 201 is not restricted to either of these types.

The main storage unit 202 is a device that stores a program for realizing the viewer terminal 20 or the distributor terminal 30, and calculation results output from the processor 201. The main storage unit 202 can be, for example, at least one of a ROM and a RAM.

The auxiliary storage unit 203 is usually a device capable of storing a larger amount of data than the main storage unit 202. The auxiliary storage unit 203 is composed of a non-volatile storage medium such as a hard disk or a flash memory. The auxiliary storage unit 203 stores the client program P2 and various types of data for getting the terminal computer 200 to function as a viewer terminal 20 or a distributor terminal 30. For example, the auxiliary storage unit 203 may store data for virtual objects such as avatars and/or virtual space.

The communication unit 204 is a device that performs data communication with other computers via a communication network N. The communication unit 204 can be, for example, a network card or a wireless communication module.

The input interface 205 is a device that receives data based on operations or controls performed by the user. The input interface 205 can be, for example, at least one of a keyboard, control buttons, a pointing device, a microphone, a sensor, and a camera. The keyboard and control buttons may be displayed on a touch panel. There are no restrictions on the type of input interface 205 or data that is inputted. For example, the input interface 205 may receive data inputted or selected using a keyboard, control buttons, or a pointing device. Alternatively, the input interface 205 may receive voice data inputted using a microphone. Alternatively, the input interface 205 may receive video data (such as moving image data or still image data) captured by a camera.

The output interface 206 is a device that outputs data processed by the terminal computer 200. For example, the output interface 206 can be composed of at least one of a monitor, a touch panel, an HMD, and a speaker. Display devices such as monitors, touch panels, and HMDs display processed data on a screen. The speaker outputs voice indicated by processed voice data.

The imaging unit 207 is a device, specifically a camera, used to capture images of the real world. The imaging unit 207 may capture moving images or still images. When shooting video, the imaging unit 207 processes video signals at a predetermined frame rate to acquire a series of frame images arranged in time series as moving images. The imaging unit 207 can also function as an input interface 205.

Each functional element of the viewer terminal 20 or the distributor terminal 30 is realized by loading the client program P2 in the processor 201 or the main storage unit 202 and executing the program. The client program P2 contains code for realizing each functional element of the viewer terminal 20 or the distributor terminal 30. The processor 201 operates the communication unit 204, the input interface 205, the output interface 206, or the imaging unit 207 according to the client program P2, and writes and reads data to and from the main storage unit 202 or the auxiliary storage unit 203. Each functional element of the viewer terminal 20 or the distributor terminal 30 is realized by this processing.

At least one of the server program P1 and the client program P2 may be provided after being recorded on a physical recording medium such as a CD-ROM, a DVD-ROM, or a semiconductor memory. Alternatively, at least one of these programs may be provided via a communication network as data signals superimposed on carrier waves. These programs may be provided separately or together.

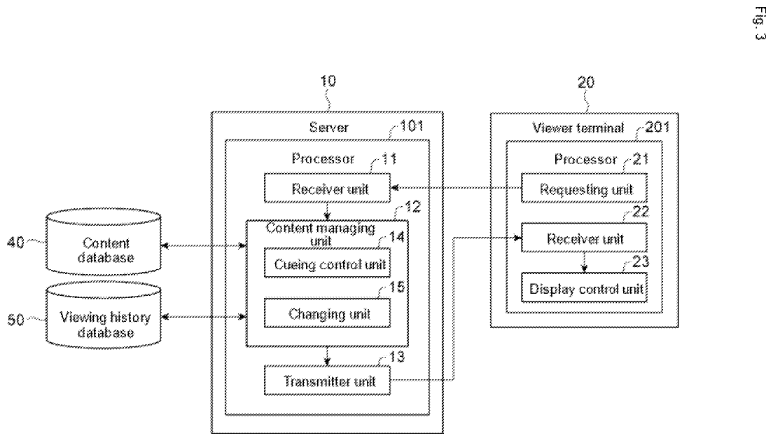

FIG. 3 is a diagram showing an example of the functional configuration related to the content distribution system 1. The server 10 includes a receiving unit 11, a content managing unit 12, and a sending unit 13 as functional elements. The receiving unit 11 is a functional element that receives data signals sent from a viewer terminal 20. The content managing unit 12 is a functional element that manages content data. The sending unit 13 is a functional element that sends content data to a viewer terminal 20. The content managing unit 12 includes a cueing control unit 14 and a changing unit 15. The cueing control unit 14 is a functional element that controls the cueing positions in the content based on a request from a viewer terminal 20. The changing unit 15 is a functional element that changes some of the content based on a request from a viewer terminal 20. In one example, content changes include at least one of adding an avatar, replacing an avatar, and changing the position of an avatar in virtual space.

Cueing means finding the beginning of the section of the content to be played, and cueing position means the beginning of that section. The cueing position may be a position before the current playback position in the content. In this case, the playback position is returned to a past position. The cueing position may be a position after the current playback position in the content. In this case, the playback position is advanced to a future position.

The viewer terminal 20 includes a requesting unit 21, a receiving unit 22, and a display control unit 23 as functional elements. The requesting unit 21 is a functional element that requests various control operations related to the content from the server 10. The receiving unit 22 is a functional element that receives content data. The display control unit 23 is a functional element that processes the content data and displays the content on the display device.

### [System Operations]

Operations performed by the content distribution system 1 (more specifically, operations performed by the server 10) will now be described along with the content distribution method according to the present embodiment. The following description focuses on image processing, and a detailed description of audio output embedded in the content has been omitted.

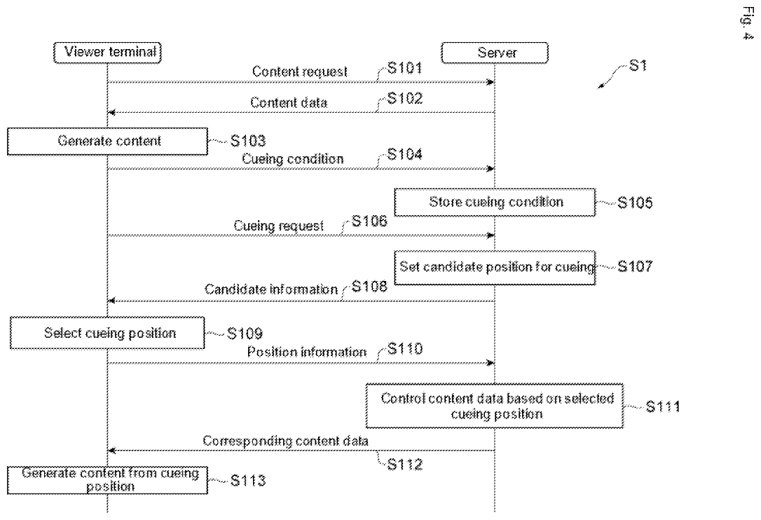

First, cueing of the content will be described. FIG. 4 is a sequence diagram showing an example of content cueing using processing flow S1.

In step S101, the viewer terminal 20 sends a content request to the server 10. A content request is a data signal asking the server 10 to play content. When the viewer operates the viewer terminal 20 to start playing the desired content, the requesting unit 21 responds to the operation by generating a content request including the user ID of the viewer and the content ID of the selected content. The requesting unit 21 then sends the content request to the server 10.

In step S162, the server 10 responds to the content request by sending the content data to the viewer terminal 20. When the receiving unit 11 receives the content request, the content managing unit 12 retrieves the content data corresponding to the content ID indicated in the content request from the content database 40 and outputs the content data to the sending unit 13. The sending unit 13 then sends the content data to the viewer terminal 20.

The content managing unit 12 may retrieve content data so that the content is played from the beginning, or may retrieve content data so that the content is played from the middle. When the content is played from the middle, the content managing unit 12 retrieves the viewing data corresponding to the combination of user ID and content ID indicated in the content request from the viewing history database 50 to determine the playback end position from the previous viewing session. The content managing unit 12 then controls the content data so that the content is played back from the playback end position.

The content managing unit 12 generates a viewing data record corresponding to the current content request when the content data starts to be sent, and registers the record in the viewing history database 50.

In step S103, the viewer terminal 20 plays the content. When the receiving unit 22 receives the content data, the display control unit 23 processes the content data and displays the content on the display device. In one example, the display control unit 23 generates content video by executing a rendering based on the content data, and displays the content video on the display device. The viewer terminal 20 outputs audio from the speaker in sync with display of the content video. In the present embodiment, the viewer terminal 20 performs the rendering, but there are no restrictions on the computer that performs the rendering. For example, the server 10 may perform the rendering. In this case, the server 10 sends the content video generated by the rendering to the viewer terminal 20 as content data.

In one example, the viewer can specify cueing conditions. In this case, the processing in steps S104 and S105 is executed. Note that these two steps are not required. A cueing condition is a condition taken into consideration when the server 10 dynamically sets a cueing candidate position. A cueing candidate position refers to a position provided to the viewer as a cueing position option, and is referred to simply as a “candidate position” below.

In step S104, the viewer terminal 20 sends a cueing condition to the server 10. When the viewer operates the viewer terminal 20 to set a cueing condition, the requesting unit 21 responds by sending the cueing condition to the server 10. There are no particular restrictions on the cueing condition setting method and content. For example, the viewer may select a specific virtual object from a plurality of virtual objects appearing in the content, and the requesting unit 21 may send a cueing condition indicating the selected virtual object. The content managing unit 12 provides a menu screen to be operated on the viewer terminal 20 via the sending unit 13, and the display control unit 23 displays the menu screen so that the viewer can select a specific virtual object from among a plurality of virtual objects. Some or all of the plurality of virtual objects presented to the viewer as options may be avatars. In this case, the cueing condition may indicate the selected avatar.

In step S105, the server 10 saves the cueing condition. When the receiving unit 11 receives the cueing condition, the cueing control unit 14 stores the cueing condition in the viewing history database 50 as at least a portion of the cueing information for the viewing data corresponding to what is currently being viewing.

In step S106, the viewer terminal 20 sends a cueing request to the server 10. A cueing request is a data signal for changing the playback position. When the viewer performs a cueing operation such as pressing a cueing button on the viewer terminal 20, the requesting unit 21 responds by generating a cueing request and sends the cueing request to the server 10. The cueing request may indicate whether the requested cueing position is before or after the current playback position. However, the cueing request does not have to indicate a cueing direction.

In step S197, the server 10 sets a candidate position for cueing. When the receiving unit 11 receives a cueing request, the cueing control unit 14 responds to the cueing request by analyzing the content data in the currently provided content to dynamically set at least one scene in the content as a candidate position. The cueing control unit 14 then generates candidate information indicating the candidate position. Dynamically setting at least one scene in the content as a candidate position means, in short, dynamically setting a candidate position. “Dynamic setting” of a target means the computer sets the target without human intervention.

There are no particular restrictions on the specific method used to set a candidate position for cueing. In a first method, the cueing control unit 14 may set as a candidate position a scene in which a virtual object (for example, an avatar) selected by the viewer performs a predetermined operation. For example, the cueing control unit 14 retrieves the viewing data corresponding to what is currently being viewed from the viewing history database 50 and acquires a cueing condition. The cueing control unit 14 then sets as a candidate position one or more scenes in which the virtual object (for example, an avatar) indicated in the cueing condition performs a predetermined operation. Alternatively, the cueing control unit 14 may set as a candidate position one or more scenes in which a virtual object selected in real time by the viewer in the content video using, for example, a tapping operation performs a predetermined operation. In this situation, the requesting unit 21 responds to the operation performed by the viewer (for example, a tap operation) by sending information indicating the selected virtual object to the server 10 as a cueing condition. When the receiving unit 11 has received the cueing condition, the cueing control unit 14 sets as a candidate one or more scenes in which the virtual object indicated by the cueing condition performs a predetermined operation.

There are no particular restrictions on the predetermined operation performed by the selected virtual object. Predetermined operations may include at least one of entering the virtual space shown in the content video, a specific posture or movement (such as operating a clapperboard), making a specific utterance, and exiting from the virtual space shown in the content video. The entry or exit of a virtual object may be expressed by replacing a first virtual object with a second virtual object, Specific utterance means saying specific words. For example, the specific utterance may be “action”.

In a second method, the cueing control unit 14 sets as a candidate position one or more scenes in which a predetermined specific virtual object (for example, an avatar) performs a predetermined operation that is not based on a selection by the viewer (that is, without acquiring a cueing condition). In this method, the cueing control unit 14 does not acquire a cueing condition because the virtual object used to set the candidate position is predetermined. The cueing control unit 14 sets as a candidate position a scene in which a virtual object (for example, an avatar) performs a predetermined operation. As in the first method, there are no particular restrictions on the predetermined operation.

In a third method, the cueing control unit 14 may set as a candidate position one or more scenes in which the position of a virtual camera in the virtual space is switched, Switching the position of a virtual camera means the position of the virtual camera changes discontinuously from a first position to a second position.

In a fourth method, the cueing control unit 14 sets as a candidate position one or more scenes selected as a cueing position by at least one of the viewers who has sent a cueing request during past viewing of the content. The cueing control unit 14 retrieves the viewing record including the content ID of the content request from the viewing history database 50. The cueing control unit 14 then references the cueing information in the viewing record to identify one or more cueing positions selected in the past, and selects as a candidate position one or more scenes corresponding to the cueing positions.

The cueing control unit 14 may set as a candidate position one or more scenes using any two or more of the methods described above. Regardless of the method used to set a candidate position, the cueing control unit 14 only sets a candidate position in the cueing direction when the cueing request indicates the cueing direction.

In one example, the cueing control unit 14 may set a representative image corresponding to at least one of the one or more candidate positions that has been set (for example, a representative image for each of the one or more candidate positions). A representative image is an image that has been prepared for the viewer to grasp the scene corresponding to a candidate position. There are no particular restrictions on the details of the representative image, which may be of any design. For example, a representative image may be at least one virtual object appearing in a scene corresponding to a candidate position, or may be at least the portion of the video region in which the scene appears. The representative image may represent a virtual object (that is, an avatar) selected in the first or second method described above. In both cases, the representative image is dynamically set based on the candidate position. When the representative image has been set, the cueing control unit 14 generates candidate information including the representative image in order to display a representative image corresponding to a candidate position on the viewer terminal 20.

In step S108, the sending unit 13 sends candidate information indicating one or more set candidate positions to the viewer terminal 20.

In step S109, the viewer terminal 20 selects a cueing position from one or more candidate positions. When the receiving unit 22 receives the candidate information, the display control unit 23 displays one or more candidate positions on the display device based on the candidate information. When the candidate information includes one or more representative images, the display control unit 23 displays each representative image corresponding to a candidate position. “Displaying a representative image corresponding to a candidate position” means displaying a representative image so that the viewer can determine the corresponding relationship between the representative image and the candidate position.

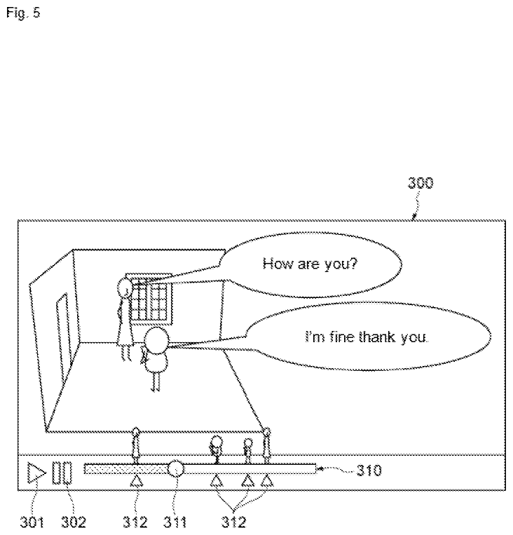

FIG. 5 is a diagram showing an example of a display of a cueing candidate position. In this example, the content video is played on a video application 300 that includes a play button 301, a pause button 302, and a seek bar 310. The seek bar 310 includes a slider 311 that indicates the current playback position. In this example, the display control unit 23 places four marks 312 along the seek bar 310 indicating four candidate positions. One of the marks 312 indicates a position in the past relative to the current playback position, and the remaining three marks 312 indicate positions in the future relative to the current playback position. In this example, a virtual object (avatar) corresponding to a mark 312 (a candidate position) is displayed as a representative image above the mark 312 (in other words, on the opposite side of the mark 312 with the seek bar 310 in between). This example shows four representative images corresponding to each of the four marks 312.

In step S110, the viewer terminal 20 sends position information indicating the selected candidate position to the server 10. When the viewer performs an operation of selecting a candidate position, the requesting unit 21 responds by generating position information indicating the selected candidate position. In the example shown in FIG. 5, when the viewer selects a mark 312 using, for example, a tapping operation, the requesting unit 21 generates position information indicating the candidate position corresponding to the mark 312 and sends the position information to the server 10.

In step S111, the server 10 controls the content data based on the selected cueing position. When the receiving unit 11 receives the position information, the cueing control unit 14 specifies the cueing position based on the position information. The cueing control unit 14 retrieves the content data corresponding to the cueing position from the content database 40, and outputs the content data to the sending unit 13 so that the content is played from the cueing position. In other words, the cueing control unit 14 sets at least one candidate position as a cueing position. The cueing control unit 14 also accesses the viewing history database 50 and records cueing information indicating the set cueing position in the viewing data corresponding to the content currently being viewed.

In step S112, the sending unit 13 sends the content data corresponding to the selected cueing position to the viewer terminal 20.

In step S113, the viewer terminal 20 plays the content from the cueing position. When the receiving unit 22 receives the content data, the display control unit 23 processes the content data in the same manner as in step S103 and displays the content on the display device.

During a single viewing, the processing in steps S106 to S113 may be executed each time the viewer performs a cueing operation. When the viewer changes a cueing condition, the processing in steps S104 and S105 can be executed once again.

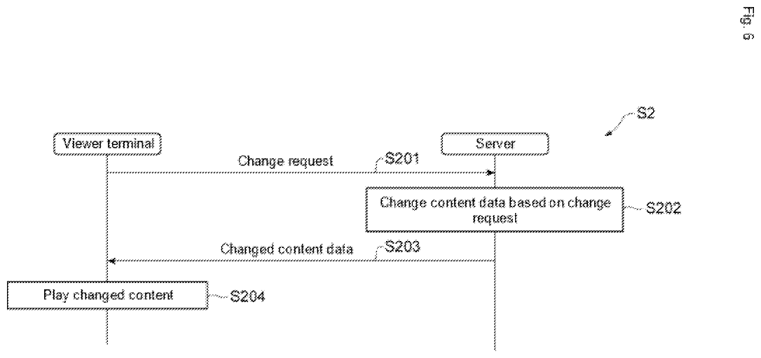

The following is an explanation of how some of the content is changed. FIG. 6 is a sequence diagram showing an example of a content change using processing flow S2.

In step S201, the viewer terminal 20 sends a change request to the server 10. A change request is a data signal used to ask the server 10 to change some of the content. In one example, the content change may include at least one of the addition of an avatar and the replacement of an avatar. When the viewer operates the viewer terminal 20 to make the desired change, the requesting unit 21 responds by generating a change request indicating how the content is to be changed. When the content change involves adding an avatar, the requesting unit 21 may generate a change request containing the avatar ID of that avatar. When the content change involves replacing an avatar, the requesting unit 21 may generate a change request that includes the avatar ID of the replaced avatar and the avatar ID of the replacing avatar. Alternatively, the requesting unit 21 may generate a change request including the avatar ID of the replacing avatar without including the avatar ID of the replaced avatar. Here, the replaced avatar refers to the avatar that is not displayed after the replacement, and the replacing avatar refers to the avatar that is displayed after the replacement. Both the replacing avatar and the replaced avatar may be avatars corresponding to the viewer. The requesting unit 21 sends the change request to the server 10.

In step S202, the server 10 modifies the content data based on the change request. When the receiving unit 11 receives the change request, the changing unit 15 changes the content data based on the change request.

When the change request indicates adding an avatar, the changing unit 15 retrieves the model data corresponding to the avatar ID indicated in the change request from the content database 40 or some other storage unit, and embeds or associates the model data with the content data. The changing unit 15 also changes the scenario in order to add the avatar to the virtual space. This adds a new avatar to the virtual space. For example, the changing unit 15 may provide content video with the avatar viewing the virtual world by placing the added avatar at the position of the virtual camera. The changing unit 15 may change the position of an existing avatar present in the virtual space before the change, and place another avatar at the position of the existing avatar. The changing unit 15 may also change the orientation or posture of other related avatars.

When the change request indicates replacement of an avatar, the changing unit 15 retrieves the model data corresponding to the avatar ID of the replaced avatar from the content database 40 or some other storage unit, and replaces the model data of the replaced avatar with this model data. This replaces one avatar with another in the virtual space. The changing unit 15 may dynamically set the replaced avatar. The avatar selected as the replaced avatar may be, for example, an avatar that is not the first to speak, an avatar with a specific object, or an avatar without a specific object. When the content is educational content, the replaced avatar may be a student avatar or a teacher avatar.

In step S213, the sending unit 13 sends the changed content data to the viewer terminal 20.

In step S214, the viewer terminal 20 plays the modified content. When the receiving unit 22 receives the content data, the display control unit 23 processes the content data in the same manner as in step S103 and displays the content on the display device.

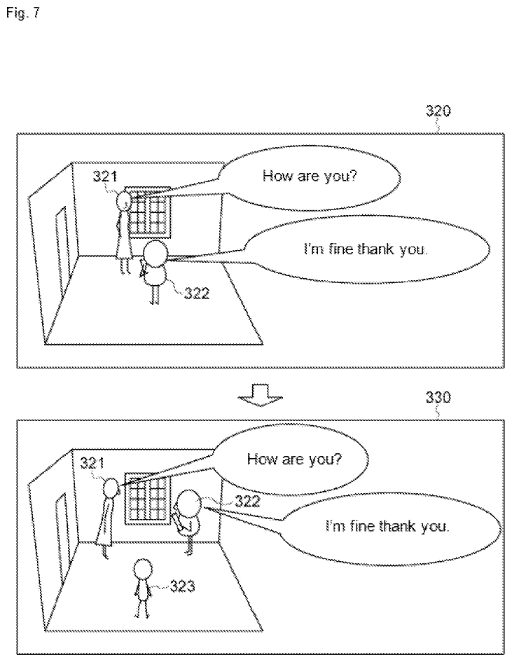

FIG. 7 is a diagram showing an example of changing the content. In this example, the original video 320 is changed to the changed video 330. The original video 320 shows a scene in which a teacher avatar 321 and a first student avatar 322 are practicing English conversation. In this example, the changing unit 15 places a second student avatar 323 at the position where the first student avatar 322 was present, changes the position of the first student avatar 322, and changes the posture of the teacher avatar 321 so that the teacher avatar 321 faces the first student avatar 322. In one example, the modified video 330 shows, by time-shifted or on-demand viewing, the viewer currently viewing the content as a second student avatar 323 in a virtual space observing a conversation between the teacher avatar 321 and the first student avatar 322.

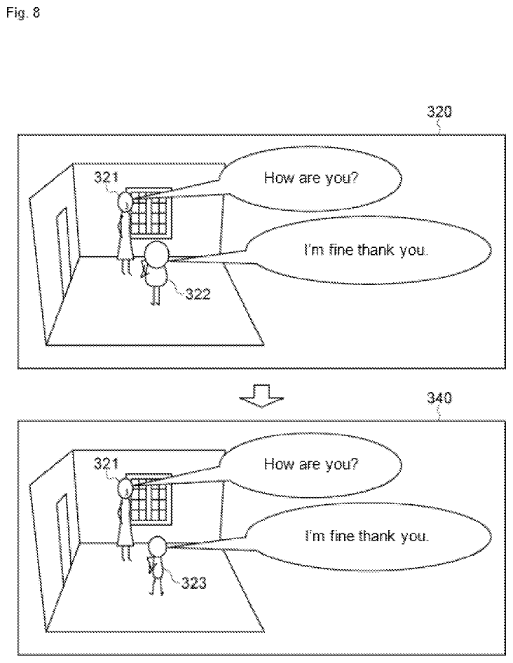

FIG. 8 is a diagram showing another example of changing the content. In this example, the changing unit 15 changes the original video 320 to modified video 340 by replacing the first student avatar 322 with a second student avatar 323. In the modified video 340, a scene is created by time-shifted or on-demand viewing in which the viewer currently viewing the content appears in the virtual space as a second student avatar 323 replacing the first student avatar 322 to practice English conversation with the teacher avatar 321.

### [Effects]

As mentioned above, the content distribution system in one aspect of the present disclosure comprises one or more processors. At least one of the one or more processors acquires content data on existing content that represents virtual space. At least one of the one or more processors analyzes the content data to dynamically set at least one scene in the content as one or more candidate positions for cueing in the content. At least one of the one or more processors sets one of the one or more candidate positions as a cueing position.

The content distribution method in another aspect of the present disclosure is executed by a content distribution system including one or more processors. This content distribution method comprising the steps of: acquiring content data on existing content that represents virtual space; analyzing the content data to dynamically set at least one scene in the content as one or more candidate positions for cueing in the content, and setting one of the one or more candidate positions as a cueing position.

The content distribution program in another aspect of the present disclosure executes in a computer the steps of: acquiring content data on existing content that represents virtual space; analyzing the content data to dynamically set at least one scene in the content as one or more candidate positions for cueing in the content, and setting one of the one or more candidate positions as a cueing position.

In these aspects of the present disclosure, a predetermined scene in the virtual space is dynamically set as a candidate position for cueing, and a cueing position is set from the candidate position. In this way, viewers can easily cue content without having to adjust the cueing position themselves.

In the content distribution system according to another aspect of the present disclosure, at least one of the one or more processors sends the at least one candidate position to a viewer terminal, and at least one of the one or more processors sets one candidate position selected by the viewer in the viewer terminal as the cueing position. In this way, the viewer can select the desired cueing position from candidate positions that have been set dynamically.

In the content distribution system according to another aspect of the present disclosure, the at least one scene includes a scene in which a virtual object performs a predetermined operation in the virtual space. By setting a candidate position based on an operation performed by a virtual object, cueing of a scene can be performed in which the cueing position can be properly estimated.

In the content distribution system according to another aspect of the present disclosure, the predetermined operation includes at least one of the entry of the virtual object into the virtual space and the exit of the virtual object from the virtual space, Because a scene can be said to be a turning point in the content, setting a scene as a candidate position makes it possible to cue a scene in which the cueing position has been properly estimated.

In the content distribution system according to another aspect of the present disclosure, entry or exit of the virtual object is represented by replacement with another virtual object. Because a scene can be said to be a turning point in the content, setting a scene as a candidate position makes it possible to cue a scene in which the cueing position has been properly estimated.

In the content distribution system according to another aspect of the present disclosure, the predetermined action includes a specific utterance by the virtual object. By setting a candidate position based on an utterance made by a virtual object, cueing of a scene can be performed in which the cueing position can be properly estimated.

In the content distribution system according to another aspect of the present disclosure, the at least one scene includes a scene in which the position of a virtual camera in the virtual space is switched. Because a scene can be said to be a turning point in the content, setting a scene as a candidate position makes it possible to cue a scene in which the cueing position has been properly estimated.

In the content distribution system according to another aspect of the present disclosure, at least one of the one or more processors retrieves viewing data indicating the history of cueing performed by each user from a viewing history database, and uses the viewing data to set at least one scene selected as the cueing position for the content during past viewing as the at least one candidate position. By setting a cueing position selected in the past as a candidate position, a scene can be presented that has a high probability of being selected by the viewer as a candidate position.

In the content distribution system according to another aspect of the present disclosure, at least one of the one or more processors sets a representative image corresponding to at least one of the one or more candidate positions, and at least one of the one or more processors displays the representative image on the viewer terminal in a manner corresponding to the candidate position. By displaying a representative image that corresponds to a candidate position, the viewer can get a preview of the scene corresponding to the candidate position. The viewer can think about or confirm the type of scene that should be a candidate for the cueing position before performing the cueing operation using representative images. As a result, the desired scene can be immediately selected.

In the content distribution system according to another aspect of the present disclosure, the content is educational content that includes an avatar corresponding to a teacher or a student. In this case, the viewer can easily cue the educational content without having to adjust the cueing position himself or herself.

### Modified Examples

A detailed description was provided above based on an embodiment of the disclosure. However, the present disclosure is not limited to the embodiment described above. Various modifications can be made without departing from the scope and spirit of the present disclosure.

In the present disclosure, expressions corresponding to “at least one processor executing a first process, a second process, and an n^{th} process” includes cases in which the executing unit (that is, the processor) used to perform the n processes from the first process to the n^{th} process changes in the middle. In other words, these expressions include both cases in which all n processes are executed by the same processor and cases in which the processor performing the n processes changes according to any given plan.

The processing steps in the method executed by at least one processor are not limited to those provided in the embodiment described above. For example, some of the steps (processes) described above may be omitted, or the steps may be executed in a different order. Any two or more of the steps described above may be combined, or some of the steps may be modified or deleted. Alternatively, other steps may be performed in addition to the steps described above.

### REFERENCE SIGNS LIST

1: Content distribution system
10: Server
11: Receiving unit
12: Content managing unit
13: Sending unit
14: Cueing control unit
15: Changing unit
20: Viewer terminal
21: Requesting unit
22: Receiving unit
23: Display control unit
30: Distributor terminal
40: Content database
50: Viewing history database
300: Video application
310: Seek bar
312: Mark
P1: Server program
P2: Client program

1. A content distribution system comprising one or more processors,
wherein at least one of the one or more processors is configured to acquire content data on existing content that represents virtual space,
wherein at least one of the one or more processors is configured to analyze the content data to dynamically set at least one scene in the existing content as one or more candidate positions for cueing in the existing content, and
wherein at least one of the one or more processors is configured to set one of the one or more candidate positions as a cueing position.

2. The content distribution system according to claim 1, wherein at least one of the one or more processors is configured to sends the at least one candidate position to a viewer terminal, and
wherein at least one of the one or more processors is configured to set one candidate position selected by the viewer in the viewer terminal as the cueing position.

3. The content distribution system according to claim 1, wherein the at least one scene includes a scene in which a virtual object performs a predetermined operation in the virtual space.

4. The content distribution system according to claim 3, wherein the predetermined operation includes at least one of the entry of the virtual object into the virtual space and the exit of the virtual object from the virtual space.

5. The content distribution system according to claim 4, wherein entry or exit of the virtual object is represented by replacement with another virtual object.

6. The content distribution system according to claim 3, wherein the predetermined action includes a specific utterance by the virtual object.

7. The content distribution system according to claim 1, wherein the at least one scene includes a scene in which the position of a virtual camera in the virtual space is switched.

8. The content distribution system according to claim 1, wherein at least one of the one or more processors is configured to:
retrieve viewing data indicating the history of cueing performed by each user from a viewing history database, and
use the viewing data to set at least one scene selected as the cueing position for the content during past viewing as the at least one candidate position.

9. The content distribution system according to claim 1, wherein at least one of the one or more processors is configured to set a representative image corresponding to at least one of the one or more candidate positions, and at least one of the one or more processors is configured to display the representative image on the viewer terminal in a manner corresponding to the candidate position.

10. The content distribution system according to claim 1, wherein the existing content is educational content that includes an avatar corresponding to a teacher or a student.

11. A content distribution method executed by a content distribution system including one or more processors, the content distribution method comprising the steps of:
acquiring content data on existing content that represents virtual space;
analyzing the content data to dynamically set at least one scene in the existing content as one or more candidate positions for cueing in the existing content, and
setting one of the one or more candidate positions as a cueing position.

12. A content distribution program executing in a computer the steps of:
acquiring content data on existing content that represents virtual space;
analyzing the content data to dynamically set at least one scene in the existing content as one or more candidate positions for cueing in the existing content, and
setting one of the one or more candidate positions as a cueing position.
